(19) United States
(12) Patent Application Publication
(10) Pub. No.: US 2003/0096171 A1
(43) Pub. Date: May 22, 2003

(54) Nonwoven separator for electrochemical cell

(76) Inventors: Gary Lee Thrasher, Bay Village, OH (US); Jean-Francois Audebert, Westlake, OH (US); Hans-Joachim Feistner, Abtsteinach (DE); Mathias Weiss, Ludwigsburg (DE); Gunter Frey, Schliengen (DE); Raoul Farer, Freiburg (DE)

Correspondence Address: GARY L. THRASHER ET AL., 25225 Detroit Road, Post Office Box 450777, Westlake, OH, 44145, US

(21) Appl. No.: 10/290,902

(22) Filed: Nov. 8, 2002

(30) Foreign Application Priority Data
Nov. 12, 2001 (DE) 10154896.6

(51) Int. Cl. H01M 2/18; H01M 2/16; H01M 10/24; H01M 2/14

(52) U.S. Cl. 429/247; 429/254; 429/255; 429/142; 429/144

(57) ABSTRACT

A low volume nonwoven separator and an electrochemical cell employing the separator are provided. The cell includes a positive electrode and a negative electrode. The nonwoven separator is disposed between the positive electrode and negative electrode. The nonwoven separator comprises, prior to insertion in the cell, a non-compressed single layer dry thickness in the range of 0.04 to 0.09 mm, and an average pore size of no greater than 14 μm. The cell further includes an electrolyte in contact with the separator and the positive and negative electrodes.

### BACKGROUND OF THE INVENTION

The present invention generally relates to electrochemical cells, i.e., batteries, and more particularly, to a nonwoven separator for use between the positive and negative electrodes in an electrochemical cell.

Alkaline electrochemical cells commonly include a steel can containing a positive electrode, referred to as the cathode, a negative electrode, referred to as the anode, a separator, and an electrolyte solution. In bobbin-type cells, the cathode, which typically includes manganese dioxide as the active material, is typically formed against the interior surface of the steel can, and the anode, which typically includes zinc powder as the active material, is generally centrally disposed in a cylindrical anode cavity formed in the center of the cathode. The separator is located between the anode and the cathode, and the alkaline electrolyte solution simultaneously contacts the anode, the cathode, and the separator. A conductive current collector is typically inserted into the anode, and a seal assembly, which generally includes a polymeric seal, provides closure to the open end of the steel can to seal the active electrochemical materials in the sealed volume of the can.

In conventional bobbin-type cells, the separator is commonly provided as a multiple layered ion permeable, nonwoven fibrous fabric which separates the anode from the cathode. The separator maintains a physical dielectric separation of the positive electrode material from the negative electrode material and allows for the transport of ions between the positive and negative electrode materials. In addition, the separator acts as a wicking medium for potassium hydroxide (KOH) solution and also acts as a collar for preventing the anode gel from falling out of the anode cavity. Examples of conventional separator materials include two or three layers of fibrous nonwoven paper, which results in a total separator dry thickness generally in the range from about 0.28 mm to 0.46 mm. Many conventional nonwoven separators have large pores and tend to expand in thickness considerably when soaked with electrolyte solution. As a consequence, such separators consume a substantial amount of volume.

Conventional separators are usually formed by either preforming the separator material into a cup-shaped basket that is subsequently inserted into a cavity formed in the cathode during assembly, or forming a basket during cell assembly by inserting into the cathode cavity multiple rectangular overlapping sheets of separating material angularly rotated relative to each other. The conventional preformed separators are typically made up of a sheet of nonwoven fabric rolled into a cylindrical shape that conforms to the inner walls of the cathode and has a closed bottom end. Alternately, a closed end may be provided by inserting a dielectric seal, in the form of a plug, in the bottom end of the steel can and inserting a convolute cylindrical separator up against the plug.

The conventional separator employs a fibrous porous paper material that generally requires multiple overlapping layers in order to maintain sufficient dielectric isolation and prevent electrical shorting between the anode and cathode. The use of thinner paper material for a conventional separator generally suffers from pores (i.e., openings) that are typically present in the conventional paper which may allow a conductive path to be formed between the anode and the cathode. It is also possible that the cathode ingredients may penetrate the separator to form a conductive path with the anode, thereby causing electrical shorting of the cell. Further, the deposition of zinc oxide within the pores of the conventional paper separator may also form an electrically conductive path that, in turn, causes electrical shorting and leads to premature discharge of the cell.

Many conventional separators employ separators having a relatively large thickness; however, such relatively thick separators generally result in increased ionic resistance which results in reduced ion diffusion through the separator, and thus limits high rate discharge performance of the cell. As a consequence, many conventional separators consume a large amount of volume within the cell, which reduces the volume that would otherwise be available for electrochemically active materials. Accordingly, it is therefore desirable to provide for a separator for use in electrochemical cells that efficiently separates the positive and negative electrodes while minimizing the amount of separator material required to separate the electrodes, thereby maximizing the volume available for electrochemically active materials and providing enhanced ion diffusion.

### SUMMARY OF THE INVENTION

The present invention improves the separation of the positive and negative electrodes in an electrochemical cell with an enhanced separator. To achieve this and other advantages, and in accordance with the purpose of the invention as embodied and described herein, one aspect of the present invention provides for an electrochemical cell having a positive electrode, a negative electrode, and a nonwoven separator disposed between the positive electrode and negative electrode. The nonwoven separator has, prior to insertion in the cell, a single layer dry thickness of less than 0.15 mm (millimeters) and an average pore diameter of no greater than 14 μm (micrometers). The cell further includes an electrolyte in contact with the separator and the positive and negative electrodes.

According to another aspect of the present invention, a separator for separating the positive and negative electrodes in an electrochemical cell is provided. The separator includes a sheet of nonwoven material having, prior to insertion in the cell, a single layer dry thickness of less than 0.15 mm and an average pore size of no greater than 14 μm.

According to a further aspect of the present invention, an electrochemical cell and separator are provided which include a separator for use in an electrochemical cell for separating a positive electrode from a negative electrode. The separator includes a nonwoven separator material having a basis weight in the range of 18 to 30 g/m² (grams per square meter), a dry thickness of less than 0.15 mm, and an average pore size of no greater than 14 μm. The separator further has at least 25 weight percent fibrillated cellulose fibers and at least 10 weight percent synthetic fiber.

These and other features, advantages and objects of the present invention will be further understood and appreciated by those skilled in the art by reference to the following specification, claims and appended drawings.

### BRIEF DESCRIPTION OF THE DRAWING

In the drawing:

FIG. 1 is a longitudinal cross-sectional view of an electrochemical cell employing a separator according to the present invention.

### DETAILED DESCRIPTION OF THE PREFERRED EMBODIMENT

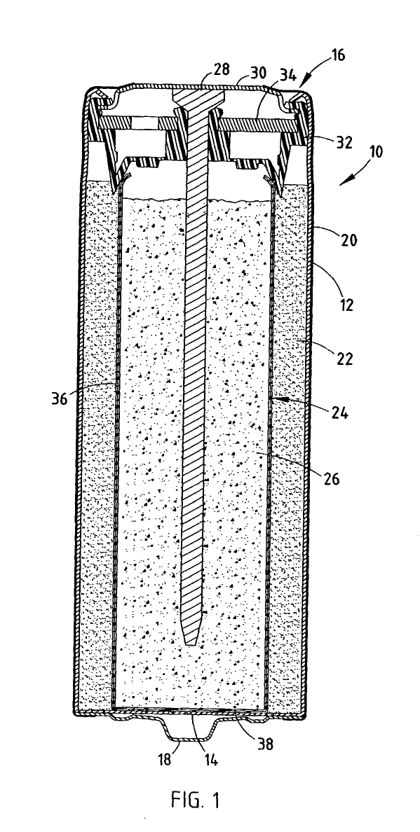

Referring to FIG. 1, a cylindrical alkaline electrochemical cell 10 is shown therein. The electrochemical cell 10 includes a cylindrical steel can 12 having a closed bottom end 14 and an open top end 16. The closed bottom end of can 12 further includes a positive cover 18 welded or otherwise attached thereto and formed of plated steel, with a protruding nub at its center region, which forms the positive contact terminal of cell 10. Assembled to the open top end 16 of steel can 12 is a cover and seal assembly with an outer negative cover 30 which forms the negative contact terminal of cell 10. A metallized, plastic film label 20 is formed about the exterior surface of steel can 12, except for the ends of steel can 12. The film label 20 is formed over the peripheral edge of the positive cover 18 and may extend partially onto the negative cover 30 as shown.

A tubular-shaped cathode 22 is formed about the interior surface of steel can 12. The cathode 20 may be formed of a mixture of manganese dioxide, graphite, potassium hydroxide solution, and additives. A convolute nonwoven separator 24 is disposed about the interior surface of the cathode 22. An anode 26, is disposed with an alkaline electrolyte inside the cylindrical-shaped volume inside the separator 24 and in contact with a current collector 28 which may include a conductive nail having an elongated body and an enlarged head at one end. The anode 26 may be formed of zinc powder, a gelling agent, and additives. Accordingly, the cathode 22 is configured as the positive electrode and the anode 26 is configured as the negative electrode.

The current collector 28 contacts the outer negative cover 30 which forms the negative contact terminal of cell 10. The outer negative cover 30 is preferably formed of plated steel, and may be held in contact with current collector 28 via pressure contact or a weld. An annular polymeric (e.g., nylon) seal 32 is disposed in the open end 16 of steel can 12 to prevent leakage of the electrochemically active cell materials contained in steel can 12. An inner cover 34, which is preferably formed of a rigid metal, is provided to increase the rigidity and support the radial compression of seal 32, thereby improving the sealing effectiveness. The inner cover 34 is configured to contact the central hub and peripheral upstanding wall of seal 32. Together, the current collector 28, seal 32, and inner cover 34 form a collector and seal assembly that can be inserted as a unit into the open end 16 of steel can 12 to seal the active ingredients within the active cell volume. It should be appreciated that the outer negative cover 30 is electrically insulated from steel can 12 by way of polymeric seal 32.

According to the present invention, the electrochemical cell 10 employs a thin nonwoven separator 24 exhibiting high electrical resistance (i.e., low electrical conductivity) and high ion permeation, while exhibiting low volume and, thus, leaving more volume within the steel can 12 available for electrochemically active materials. The separator 24 as shown and described herein has a cylindrical side wall 36 and a closed bottom end 38. The convolute separator 24 is formed from a sheet of nonwoven paper material that is preferably at least double-wrapped according to one embodiment to form a double layer thickness of separator material disposed between the anode 26 and cathode 22. While a double-layer convolute separator 24 is shown and described herein, it should be appreciated that the separator 24 may employ one or more layers of separator material to achieve the desired electrical resistance and ion permeation in a low volume separator, without departing from the teachings of the present invention.

The separator 24 of the present invention uses a nonwoven separator material such as pulp paper having a basis weight ranging from 18 to 28 g/m². The separator material has a single layer dry thickness of less than 0.15 mm, and preferably greater than 0.02 mm, and more preferably has a thickness in the range of 0.04 to 0.09 mm, according to one embodiment. The separator material has an average pore size of no greater than 14 μm, and more preferably in the range of 8 to 14 μm. The separator material comprises at least 45 weight percent fibrillated cellulose and at least 10 weight percent synthetic fiber. According to one embodiment, the separator 24 more preferably has at least 45 weight percent synthetic fiber. The synthetic fiber comprises polyvinyl alcohol fibers. The separator 24 employs synthetic fibers in the form of polyvinyl alcohol binder fibers soluble in water at a temperature within the range of 60° C.-90° C. depending on the molecular weight of the soluble fibers as well as synthetic fibers in the form of water insoluble polyvinyl alcohol fiber. According to one embodiment, the synthetic fibers comprise 35 weight percent insoluble polyvinyl alcohol fiber and 20 weight percent soluble polyvinyl alcohol binder fibers. Both of these fibers may have a size smaller than or equal to 1.1 dtex. The use of two different polyvinyl alcohol fibers allows for a desired pore size distribution as well as a separator material exhibiting a desirable stability.

The sheet of nonwoven separator material employs solvent-spun cellulose fibers ranging in size, prior to fibrillation, of from 0.4 to 3.0 denier, and cut length from 3 to 12 mm. The cellulose fibers are fibrillated using well-known paper-making refining and pulping process technology. The degree of fibrillation of the cellulose fibers is performed so that the fibrillated cellulose fibers exhibit Grad Shopper Riegler values preferably in the range of 30 to 65 degrees.

The separator material including the cellulose fibers may employ lyocell pulp which is commercially available from pulp manufacturers. One example of a commercially available lyocell pulp may be obtained from STW (Schwarzwalder Textil-Werke) of Germany, and is commercially available as lyocell pulp VZL.

The nonwoven separator 24 may be manufactured by processing the lyocell pulp to produce a sheet of paper in a manner known in manufacturing paper in the paper industry. In doing so, the cellulose fibers are fibrillated to achieve the desired result as described herein. From the sheet of separator material, individual separators are cut and wound to form a cylindrical shaped basket having a closed end. According to one example, the sheet of separator material may be formed into a cylindrical shape and inserted into a cell as disclosed in U.S. Pat. No. 6,270,833, the disclosure of which is hereby incorporated by reference. The aforementioned patent describes forming a substantially cylindrical-shaped separator having a rounded closed end.

Each individually formed separator is then inserted into the steel can against the cathode of a corresponding electrochemical cell so as to separate the positive and negative electrodes. The anode and electrolyte solution are then injected into the cell, following insertion of the separator. Thereafter, the collector and seal assembly are assembled to seal closed the open end of the steel can.

The separator 24 may be employed in various types and sizes of electrochemical cells. For example, electrochemical cells employing the separator 24 of the present invention may be used in cylindrical electrochemical cells of the AAAA-size, AAA-size, and AA-size cells. Typical maximum battery dimensions of diameter and height typically used in AAA-size cells are 10.5 mm in diameter and 40.5 mm in height. Typical minimum dimensions for an AA-size cell include a diameter of 14.5 mm and a height of 50.5 mm. Typical maximum dimensions for an AAAA-size cell include a diameter of 8 mm and a height of 42 mm. Electrochemical cells employing the separator 24 according to the present invention achieve reduced separator thickness and, thus, the result is increased volume available for electrochemically active components. This results in additional available internal volume in the cell available for the electrochemically active components by employing the separator of the present invention.

Electrochemical cells employing the separator 24 according to the present invention are able to achieve enhanced electrochemical cell performance. A well-known standard test employable to test wasteful discharge of a battery is known as the general purpose intermittent (GPI) test. The GPI test generally requires that each cell be discharged across a known resistance resistor for five minutes at the beginning of consecutive twenty-four hour periods until the closed circuit voltage of the cell drops below 0.9 volts. Consequently, the cell is “on test” for five minutes and is “at rest” for twenty-three hours and fifty-five minutes. If the partially discharged open circuit voltage of the cell begins to recover (i.e., increase) immediately after the cell has been removed from the discharge circuit, then the separator 24 has prevented the formation of a conductive path (e.g., short circuit) through the separator. However, if the open circuit voltage of the cell drops more than 0.05 volts during the rest period, then an electrical short circuit has been established through the separator. The GPI test is used to test separator materials against the formation of zinc-dentrite shortening. For AAA-size cells, the GPI test employs a resistor with a resistance of 5.1 ohms, whereas an AA-size cell employs a resistor with a resistance of 3.9 ohms for the GPI test.

AAA-size electrochemical cells employing the separator 24 of to the present invention were tested according to the GPI test and provided an open circuit voltage that did not decline more than 0.05 volts while the cells were disconnected from any discharge circuit and after the cells had been discharged across a 5.1 ohm resistor for five minutes at the beginning of consecutive twenty-four hour periods until the closed circuit voltage of the cells reached 0.9 volts. Likewise, AA-size cells were tested employing the separator 24 of the present invention and the open circuit voltage did not decline more than 0.05 volts while the cells were disconnected from any discharge circuit and after the cells had been discharged across a 3.9 ohm resistor for five minutes at the beginning of consecutive twenty-four hours period until the closed circuit voltage of the cells reached 0.9 volts.

The average pore diameter size of the separator material is measured according to a well-known industry standard referred to as ASTM (American Society for Testing Materials) method E-1294. The aforementioned ASTM method E-1294 is disclosed in the American Society for Testing Materials, Designation: E-1294-89 (reapproved 1999), entitled “Standard Test Method For Pore Size Characteristics of Membrane Filters Using Automated Liquid Porosimeter,” pages 1-2, which is hereby incorporated by reference. The ASTM method E-1294 standard test employs a filter wet with liquid exhibiting properties similar to those of array of liquid filled capillaries, in which the sample under test is thoroughly wetted with liquid of low surface tension and low vapor pressure and placed in a sample holder assembly. An increasing air pressure is applied upstream of the sample and, as successively smaller pores empty, the air flow across the sample is recorded as a function of applied pressure. The point of first flow is identified as the bubble point (maximum pore size). This continues until the smallest detectable pore is reached. This information is then compared with the flow rate against applied pressure response for the dry sample. The pore size distribution is then obtained from wet and dry curves established by the test procedure standard.

### EXAMPLES

The separator 24 and its characteristics according to the present invention are subsequently described in greater detail by the following four examples. For each example three AAA-size electrochemical cells were made with ring molded tubular cathodes comprising manganese dioxide and graphite, anodes comprising particulate zinc, KOH electrolyte and a binder; a current collector and seal assembly to seal the battery closed, and a double wrap convolute separator according to the present invention. The fibrillated cellulose fibers used were lyocell pulp of type VZL purchased from STW of Germany, which is characterized by its Grad Shopper Riegler values. The respective air screen analysis is shown in Table 1. The average pore size (MFP) of the separator was determined according to ASTM method E 1294 (Coulter Porometer). Air permeability values of the separator ranged from 35 to 100 liter/s/m². The individual components of the separator are summarized in Table 1. Dry thickness was determined according to EN ISO 9073-02. GPI tests performed on the test cells of this invention showed that all cells successfully prevented the formation of an internal short circuit.

TABLE 1

| | | Sample No. | | | |
|---|---|---|---|---|---|
| | | 1 | 2 | 3 | 4 |
| lyocell pulp | dtex: | 1.7 | 1.7 | 1.7 | 1.7 |
| | Pulp type: | VZL | VZL | VZL | VZL |
| | Grad Shopper Riegler: | 50 | 48.5 | 52 | 50 |
| | air screen analysis: | | | | |
| | remainder > 100 pm: | 97.8% | 97.6% | 99.0% | 97.8% |
| | remainder > 200 pm: | 96.6% | 96.2% | 98.6% | 96.6% |
| | remainder > 500 pm: | 92.8% | 93.4% | 95.8% | 92.8% |
| | remainder > 1000 pm: | 92.2% | 91.4% | 71.2% | 92.2% |
| | Weight percent of total: | 45.0 | 44.1 | 45.0 | 45.0 |
| PVA | dtex: | 0.33 | 0.33 | 0.33 | 0.33 |
| | weight percent of total: | 35.0 | 34.5 | 35.0 | 35.0 |
| PVA binder-fiber | dtex: | 1.1 | 1.1 | 1.1 | 1.1 |
| | weight percent of total: | 20.0 | 21.3 | 20.0 | 20.0 |

Nonwoven (Separator)

| | | | | | |
|---|---|---|---|---|---|
| g/m² | | 24.1 | 24.5 | 26.0 | 23.5 |
| | | 0.074 | 0.09 | 0.07 | 0.069 |
| air permeability dm³/s*m²: | 51 | 60 | 46 | 52 | |
| KOH absorption )g/m²) | 151 | 154 | 133 | 164 | |
| KOH soaking height (mm): | | | | | |
| (1 min): | Machine direction | 11 | 12 | 15 | 12 |
| | Cross direction | 10 | 10 | 14 | 10 |
| (10 min): | Machine direction | 32 | 32 | 43 | 32 |
| | Cross direction | 27 | 29 | 38 | 29 |

Accordingly, the separator employed in electrochemical cells according to the present invention advantageously provides for dielectric separation between the positive and negative electrodes and allows adequate ion permeation therebetween, while consuming a low amount of volume. As a consequence, a greater amount of volume remains available within the cell to employ a greater amount of electrochemically active material, and therefore allows for enhanced electrochemical cell service.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

The invention claimed is:

1. An electrochemical cell comprising:
a positive electrode;
a negative electrode;
a nonwoven separator disposed between the positive electrode and the negative electrode, said nonwoven separator comprising, prior to insertion in said cell, a single layer dry thickness of less than 0.15 mm and an average pore diameter of no greater than 14 μm; and
an electrolyte in contact with said separator and said positive and negative electrodes.

2. The electrochemical cell as defined in claim 1, wherein the separator has a single layer dry thickness in the range of 0.04 to 0.09 mm.

3. The electrochemical cell as defined in claim 1, wherein said separator has a single layer dry thickness of at least 0.02 mm.

4. The electrochemical cell as defined in claim 1, wherein at least a double layer of said separator is disposed between the positive and negative electrodes.

5. The electrochemical cell as defined in claim 1, wherein said separator has an average pore diameter in the range of 8 to 14 μm.

6. The electrochemical cell as defined in claim 1, wherein said separator comprises at least 45 weight percent fibrillated cellulose fibers and at least 10 weight percent synthetic fiber.

7. The electrochemical cell as defined in claim 6, wherein said separator comprises at least 45 weight percent synthetic fiber.

8. The electrochemical cell as defined in claim 7, wherein said synthetic fiber comprises polyvinyl alcohol fibers.

9. The electrochemical cell as defined in claim 1, wherein said separator prior to insertion in said cell, comprises a dry basis weight in the range of 18 to 28 g/m².

10. The electrochemical cell as defined in claim 1, wherein the positive electrode comprises manganese dioxide and the negative electrode comprises zinc, and wherein said cell is an AAA-size electrochemical cell having an open circuit voltage that does not decline more than 0.05 volts while the cell is disconnected from any discharge circuit and after the cell has been discharged across a 5.1 ohm resistor for five minutes at the beginning of consecutive twenty-four hour periods until the closed circuit voltage of the cell reaches 0.9 volts.

11. The electrochemical cell as defined in claim 1, wherein the positive electrode comprises manganese dioxide and the negative electrode comprises zinc, and wherein the cell is an AA-size electrochemical cell having an open circuit voltage that does not decline more than 0.05 volts while the cell is disconnected from any discharge circuit and after the cell has been discharged across a 3.9 ohm resistor for five minutes at the beginning of consecutive twenty-four hour periods until the closed circuit voltage of the cell reaches 0.9 volts.

12. An alkaline electrochemical cell comprising:
a positive electrode;
a negative electrode; and
a separator located between the positive electrode and the negative electrode, said separator comprising, prior to insertion in the cell, a dry basis weight in the range of 18 to 30 g/m², a dry thickness of less than 0.15 mm, and an average pore size of no greater than 14 μm, said separator further comprising at least 25 weight percent fibrillated cellulose fibers and at least 10 weight percent synthetic fiber.

13. The electrochemical cell as defined in claim 12, wherein said separator has a single layer dry thickness in the range of 0.04 to 0.09 mm.

14. The electrochemical cell as defined in claim 12, wherein said separator has a single layer dry thickness of at least 0.02 mm.

15. The electrochemical cell as defined in claim 12, wherein the separator has an average pore size in the range of 8 to 14 μm.

16. The electrochemical cell as defined in claim 12, wherein said synthetic fiber comprises polyvinyl alcohol fibers.

17. The electrochemical cell as defined in claim 12, wherein the separator has a dry basis weight in the range of 18 to 28 g/m².

18. The electrochemical cell as defined in claim 12, wherein the separator has a basis weight ranging from 18 to 28 g/m², a dry thickness in the range of 0.04 mm to 0.09 mm and an average pore size in the range of 8 to 14 μm, and wherein said separator is comprised of at least 45 weight percent of fibrillated cellulose and at least 45 weight percent of synthetic fiber.

19. The electrochemical cell as defined in claim 12, wherein the separator comprises a polyvinyl alcohol fiber soluble in water at a temperature within the range of 60° C.-90° C. and a water insoluble polyvinyl alcohol fiber, wherein the fibers comprise a fiber size smaller than or equal to 1.1 dtex.

20. The electrochemical cell as defined in claim 12, wherein the fibrillated cellulose fibers are of a Grad Shopper Riegler value in the range of 30 to 65 degrees.

21. The electrochemical cell as defined in claim 12, wherein the separator comprises a double layer of separator material disposed between the positive and negative electrodes.

22. A separator for use in an electrochemical cell for separating a positive electrode from a negative electrode, said separator comprising a sheet of nonwoven material comprising, prior to insertion in said cell, a single layer dry thickness of less than 0.15 mm and an average pore diameter of no greater than 14 μm.

23. The separator as defined in claim 22, wherein said sheet of nonwoven material has a single layer dry thickness in the range of 0.04 to 0.09 mm.

24. The separator as defined in claim 22, wherein said separator material has a single layer dry thickness of at least 0.02 mm.

25. The separator as defined in claim 22, wherein said separator comprises a double layer of said separator material.

26. The separator as defined in claim 22, wherein said separator material has an average pore diameter in the range of 8 to 14 μm.

27. The separator as defined in claim 22, wherein the separator comprises at least 45 weight percent fibrillated cellulose fibers and at least 10 weight percent synthetic fiber.

28. The separator as defined in claim 27, wherein said separator comprises at least 45 weight percent synthetic fiber, wherein said synthetic fiber comprises polyvinyl alcohol fibers.

29. The separator as defined in claim 22, wherein said separator, prior to insertion in a cell, comprises a dry basis weight in the range of 18 to 28 g/m².

30. A separator for use in an electrochemical cell for separating a positive electrode from a negative electrode, said separator comprising a nonwoven separator material having a basis weight in the range of 18 to 30 g/m², a dry thickness of less than 0.15 mm, and an average pore size of no greater than 14 μm, said separator further comprising at least 25 weight percent fibrillated cellulose fibers and at least 10 weight percent synthetic fiber.

31. The separator as defined in claim 30, wherein said separator has a basis weight ranging from 18 to 28 g/m², a dry thickness in the range of 0.04 mm to 0.09 mm and an average pore size in the range of 8 to 14 μm, wherein the separator is comprised of at least 45 weight percent fibrillated cellulose and at least 45 weight percent of a synthetic fiber.

32. The separator as defined in claim 30, wherein said separator material has a single layer dry thickness of at least 0.02 mm.

33. The separator as defined in claim 30, wherein the separator comprises polyvinyl alcohol fibers soluble in water at a temperature within the range of 60° C.-90° C. and water insoluble polyvinyl alcohol fibers, wherein the fibers comprise a fiber size smaller than or equal to 1.1 dtex.

34. The separator as defined in claim 30, wherein the fibrillated cellulose fibers are of Grad Shopper Riegler values in the range of 30 to 65 degrees.

35. The separator as defined in claim 30, wherein said separator comprises at least a double layer of said separator material.
